(19) United States
(12) Patent Application Publication
(10) Pub. No.: US 2010/0243558 A1
(43) Pub. Date: Sep. 30, 2010

(54) MAINTAINING ACTIVATED SLUDGE IN SUSPENSION

(76) Inventor: ALEXANDER EKSTER, Fremont, CA (US)

Correspondence Address: Patent Jurist, 2225 East Bayshore Road, Suite 200, Palo Alto, CA, 94303, US

(21) Appl. No.: 12/411,281

(22) Filed: Mar. 25, 2009

(51) Int. Cl. C02F 3/12; C02F 3/30

(52) U.S. Cl. 210/603; 210/626; 210/195.1; 210/614

(57) ABSTRACT

A method of suspending bio-solids in an activated sludge during wastewater treatment in an activated sludge system is provided. In one example embodiment, the method may include treating the activated sludge under anaerobic conditions and flowing the activated sludge through an open channel into a separation vessel. The bio-solids are suspended in the activated sludge by either intermittent agitation comprising an agitation interval and a rest interval or by upright flow of an influent and/or activated sludge. Diffusion of gas, mechanical devices, flow of an influent, and flow of the activated sludge can be utilized to agitate the bio-solids.

### TECHNICAL FIELD

The present invention relates generally to methods and systems for wastewater treatment and more specifically to suspending bio-solids in activated sludge by agitation.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Wastewater treatment is the process of removing physical, chemical, and biological contaminants from wastewater, so that the wastewater being treated can be released into the environment after the treatment. Certain contaminants are biodegradable and can be treated with biomass containing bacteria, typically referred to as bio-solids. In order to provide effective treatment, these bio-solids should be distributed substantially uniformly throughout the bulk of the activated sludge.

### OVERVIEW

Provided are descriptions of example activated sludge systems. In some example embodiments the activated sludge systems include one or more compartments where the concentration of dissolved oxygen is less than about 0.5 milligram per liter. These compartments are referred to as anaerobic compartments. Example wastewater treatment methods include suspending bio-solids using intermittent agitation. An influent is flown into the activated sludge system and is mixed with the bio-solids to form activated sludge. The bio-solids can be suspended in the activated sludge system using aeration for intermittent agitation comprising cycling between an agitating interval and a rest interval. In some other embodiments, the intermittent agitation can be achieved by mechanical mixing comprising cycling between an agitating and a rest interval. The intermittent agitation can also be used in open channels, which are, sometimes, referred to as mixed liquor channels. Mixed liquor channels are used, in certain embodiments, to flow the activated sludge into a separation vessel. In the same or other example embodiments, the system includes a system controller configurable to execute a set of instructions causing the system to effect methods described herein. In other example embodiments, the agitation in anaerobic compartments can be achieved by upward or rotating flows of wastewater or/and activated sludge. In some example embodiments, the activated sludge system can include one or more influent and/or activated sludge distribution devices to suspend the bio-solids in the anaerobic compartments.

### BRIEF DESCRIPTION OF THE DRAWINGS

Embodiments are illustrated by way of example and not limitation in the figures of the accompanying drawings, in which like references indicate similar elements and in which:

FIG. 1 is a diagram illustrating an activated sludge system for wastewater treatment, in accordance with example embodiments.

FIG. 2 is a flow chart illustrating a part of a wastewater treatment process utilizing an activated sludge, in accordance with an example embodiment.

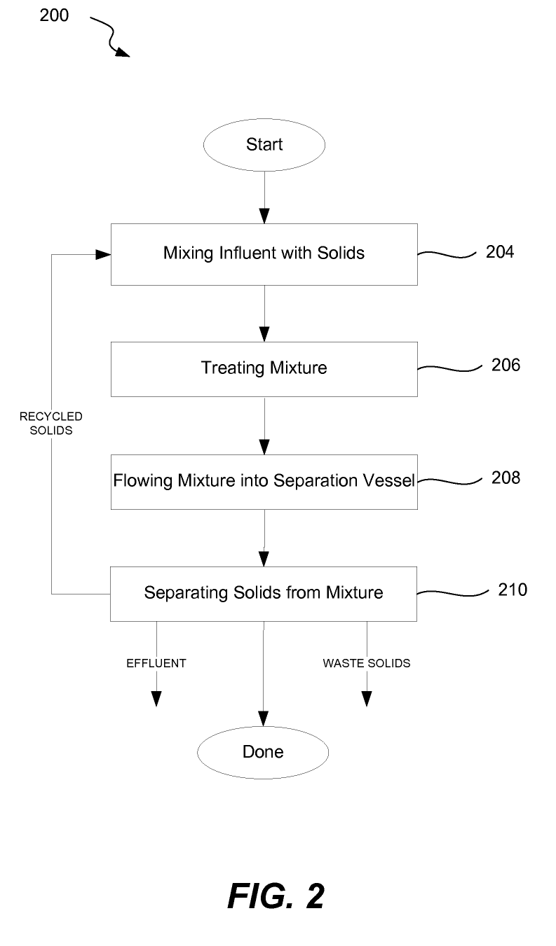

FIGS. 3A and 3B are diagrams illustrating devices for agitating bio-solids in activated sludge, in accordance with example embodiments.

FIG. 4 is a diagram illustrating a system controller configurable to control devices for agitating bio-solids in activated sludge, in accordance with an example embodiment.

FIGS. 5A and 5B are diagrams illustrating agitating of bio-solids in activated sludge, in accordance with example embodiments.

### DETAILED DESCRIPTION OF EXAMPLE EMBODIMENTS

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Organic and nitrogen-based pollutants can be removed from wastewater using an activated sludge process, which involves treatment of the wastewater with biomass and separating the biomass from the water being treated. For the purposes of this description, the terms biomass and bio-solids are used interchangeably. A combination of bio-solids and wastewater is typically referred to as activated sludge.

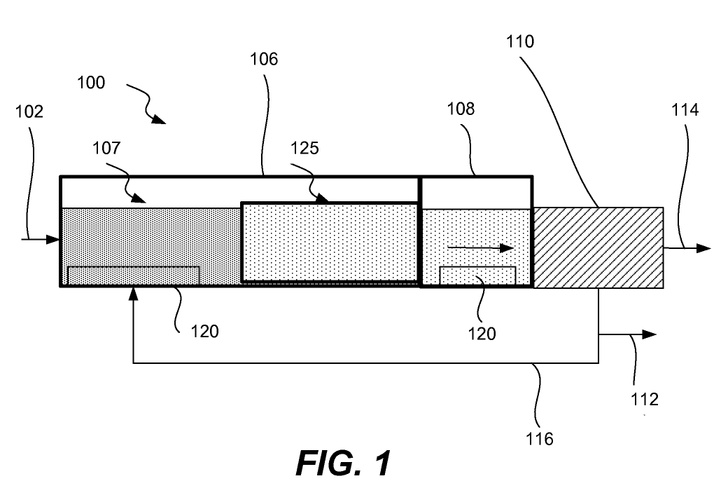

A system for implementing an activated sludge process is generally referred to as an activated sludge system. FIG. 1 is a diagram illustrating an example of such system. Such system may include an aeration tank 106 and a separation vessel 110. An influent 102 is flown into the aeration tank 106 and treated to remove organic contaminants and, in certain example embodiments, nutrients from the influent 102 using biomass.

The separation vessel 110 can be used to separate bio-solids from the treated wastewater, also called an effluent 114. Some bio-solids may be directed into a waste stream 112, while other may be directed into a recycle stream 116 which leads back into one of the chambers mentioned above. The separation vessel 110 may be a clarifier or a membrane-based vessel. In the clarifier, the bio-solids are separated from the treated wastewater by sedimentation when flocs settle toward the bottom of the clarifier in a quiescent environment. The separation results in the effluent 114 being discharged from the upper portion of the clarifier while thickened bio-solids are discharged from the bottom portion of the clarifier.

In some example embodiments, the aeration tank 106 contains anaerobic chambers 107 and aerobic chambers 125 located in different locations within an aeration tank. Substantial amount of air is supplied to the aerobic chambers 125 to oxidize pollutants and to provide agitation of the bio-solids. Little to no gas (typically air) is supplied to the anaerobic chambers 107. An open channel 108 may be used to transfer the activated sludge containing the bio-solids from the aeration tank 106 into the separation vessel 110.

In absence of agitation, the bio-solids tend to settle to the bottom of the anaerobic chamber 125 due to the gravitation forces, which results in the concentration of the bio-solids near the bottom of the chamber 125 to be higher than the concentration of the bio-solids near the top surface of the activated sludge. It is typically desirable to maintain substantially uniform concentration of the bio-solids throughout the chambers to provide for efficient wastewater treatment.

To prevent settling of the bio-solids in the activated sludge while in the open channel 108, the open channel 108 may include an agitation mechanism 120. It will be noted that the type and other characteristics of the agitation mechanism 120 may be selected based on the specific vessel utilized. Different vessels of the activated sludge system 100 may include different kinds of the agitation mechanism 120, each configured for the respective vessel.

The anaerobic chamber 107 can be equipped with a mechanism for agitating and/or mixing bio-solids in the activated sludge, for example, agitation mechanism 120. Agitation prevents bio-solids from settling on the bottom of their respective vessel. Furthermore, agitation can enhance contact between contaminants and bio-solids, thereby accelerating the process of removal of contaminants from wastewater. Additional details of particular example embodiments of the agitation mechanism 120 are provided below.

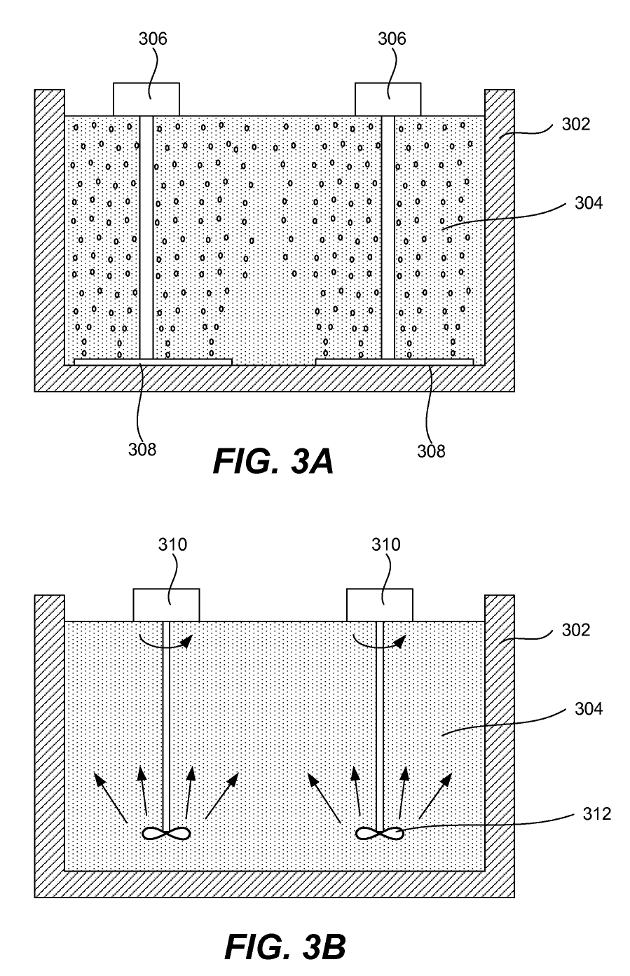

FIGS. 3A and 3B illustrate example devices for agitating bio-solids. Intermittent agitation may be performed using various mechanical methods. In the example embodiment illustrated in FIG. 3A, the intermittent agitation is implemented by providing gas (typically air) into the respective vessel 302 near the bottom of that vessel 302. The gas (typically air) bubbles, having substantially lower specific gravity, rise to the surface of the activated sludge 304 agitating the activated sludge 304 along the way and carrying some bio-solids upwards. The amount of gas (typically air) provided is controlled to maintain solids in suspension.

In another example illustrated in FIG. 3B, the agitation of bio-solids in the activated sludge 304 is performed using a propeller mixer 312 attached to the shaft of the motor 310. It will be noted that any type of a mixing blade can be utilized and the mixing blade can mix the activated sludge 304 by rotating in horizontal or vertical, clockwise or counterclockwise directions.

No power is consumed during the rest cycle. It has been experimentally confirmed that substantial energy savings result when agitation is performed intermittently as compared to the continuous agitation. A period between agitations depends on settling and horizontal velocities of the activated sludge. Increasing the horizontal velocity and decreasing the settling velocity can allow increasing rest time between agitations. Even though the bio-solids tend to settle during this period, the preceding agitation provides sufficiently uniform distribution of bio-solids throughout the volume of the respective vessel.

Experiments conducted at the 170 Millions of Gallons per Day (MGD) at San Jose/Santa Clara Water Pollution Control Plant (SJ/SC WPCP) have shown that allowing bio-solids to settle for a period of up to 20 minutes did not negatively affect ammonia, nitrate and phosphate removal and did not cause clarification problems despite slightly changed solids flux coming to the clarifier. Sludge Volume Index (SVI) during the experiments was below 100 ml/g. A higher SVI would allow prolonging the rest interval. A long absence of agitation (e.g., more than 2 hours), however, may cause deterioration of removal of soluble pollutants such as ammonia and soluble organics, due to the thinning of activated sludge in aerobic compartments, as well as overloading clarifiers with solids during the agitation period. The experiments conducted at the SJ/SC WPCP also showed that supplying small amount of air to anaerobic compartments for 2 minutes after 20 minutes of no agitation was sufficient for re-suspension of the bio-solids and reaching uniform bio-solids profile throughout the anaerobic compartment. Similar results were achieved in the mixed liquor channel by supplying small amount of air to the mixed liquor channel for 2 minutes after 20 minutes on no agitation.

Various output v. time profiles can be used during the agitation phase. These profiles may resemble trapezoidal, triangular, rectangular, sinusoidal, and other shapes. In certain example embodiments, the profile may include rest intervals when no agitation output is provided. The rest intervals may be between about 3 minutes and 30 minutes. The agitation interval lasts between 30 seconds and 15 minutes.

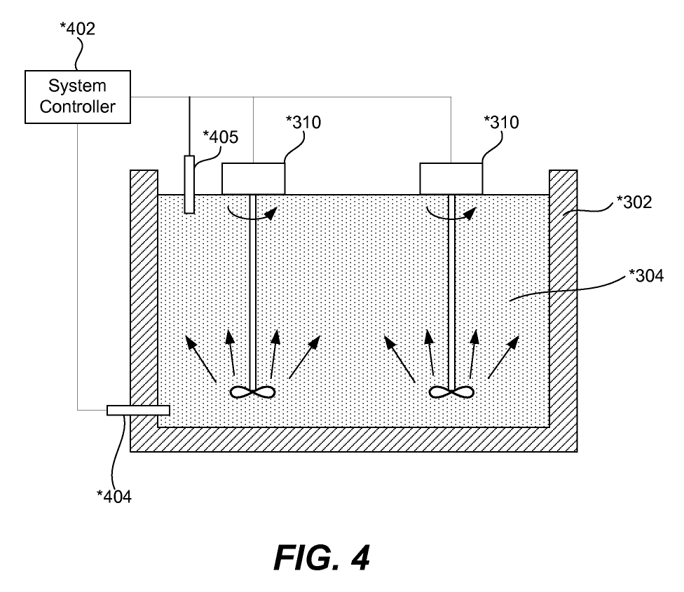

FIG. 4 illustrates an example of a system controller 402 used to control devices 310 for agitating bio-solids in the activated sludge 304, i.e., agitating devices. It will be noted that any type of the agitating devices 310 may be used such as, for example, a gas (typically air) diffuser, to direct incoming flow through the bottom of the vessel 302. The system controller 402 may be specific for each individual vessel 302 or be a part of another control system that is used to perform other functions.

The system controller 402 inputs may come from a variety of sources. For example, an operator may enter information about the process conditions used for treatment, such as bio-solids concentration, sludge volume index, settling velocity and other. In certain example embodiments, settling velocity is determined using settleometer. In other example embodiments, settling velocity is calculated using a text book equation based on a sludge volume index and a solids concentration. The system control 402 may then calculate the durations of the rest intervals based on this input. In certain example embodiments, a sensor 404 may be used to sense the concentration of bio-solids and provide this information to the system controller 402. An example of the sensor 404 includes totally suspended solids meter.

In certain example embodiments, multiple sensors (not shown) are used throughout the vessel to allow more accurately profile distribution of bio-solids in the vessel 302. The sensor 404 can be positioned near the bottom of the vessel 302 or near the top surface of the activated sludge 304. The purpose of the sensor 404 is to estimate changes in the concentration of bio-solids in order to determine how much settling of the bio-solids has occurred. For example, the sensor 404 may be installed near the bottom of the vessel 302. The system controller 402 may be provided with upper and lower thresholds of solid concentration. The upper threshold may correspond to the maximum allowable concentration of bio-solids near the bottom at which agitation is initiated. The lower threshold may correspond to the concentration at which further agitation is not necessary. Thus, an agitation may be triggered when the bio-solids settle near the bottom during treatment and their concentration exceeds the upper threshold. During the agitation, the bio-solids are forced away from the bottom causing the concentration near the bottom to decrease. Once the concentration of the bio-solids drops below the lower threshold, the agitation stops and is not resumed until partial settling of the bio-solids occurs and the concentration reaches the upper threshold. The process is then repeated.

In certain example embodiments, only the upper threshold may be used. Once this threshold is reached and the agitation is initiated, the system controller 402 may use a predetermined period for the agitation interval before the agitation is stopped. The system controller 402 then waits again until the concentration of bio-solids reaches the upper limit again, at which point the control process is repeated. In certain example embodiments comprising the multiple suspended solids meters, the agitation is stopped when the total suspended solids concentration reading reach approximately the same value

In certain example embodiments, the sensor 405 may be used to sense the water-solids interface and provide this information to the system controller 402. The sensor 405 may be positioned near the top surface of the activated sludge 304. The sensor 405 may be provided in upper and lower thresholds of the water-solids interface. The lower threshold may correspond to the lowest location of the interface at which agitation is initiated. The upper threshold may correspond to the absence of interface. During the agitation, the bio-solids are forced away from the bottom causing the solids-water interface to rise. Once the bio-solids are mixed with water, the agitation stops and is not resumed until the bio-solids partially settle and the concentration reaches the lower threshold. The process is then repeated.

In certain example embodiments, only the lower threshold may be used. Once this threshold is reached and the agitation is initiated, the system controller 402 may use a predetermined period for the agitation interval before the agitation is stopped. The system controller 402 then waits again until the water-solids interface reaches a certain depth, at which point the control process is repeated. The controller 402 typically includes one or more memory devices and one or more processors. The processor may include a CPU or a computer, analog, and/or digital input/output connections, stepper motor controller boards, etc.

In certain example embodiments, the controller 402 controls all of the activities of the system 100. The controller 402 may execute system control software including sets of instructions for controlling the timing of the processing operations, flow rates, and other process parameters. Typically, there will be a user interface associated with the controller 402. The user interface may include a display screen, graphical software displays of the apparatus and/or process conditions, and user input devices such as pointing devices, keyboards, touch screens, microphones, etc.

The computer program code for controlling the processing operations can be written in any conventional computer readable programming language: for example, assembly language, C, C++, Pascal, FORTRAN, or others. Compiled object code or script is executed by the processor to perform the tasks identified in the program.

The system software may be designed or configured in many different ways. For example, various system component subroutines or control objects may be written to control operation of the system components necessary to carry out the inventive water treatment processes. Examples of programs or sections of programs for this purpose include substrate timing of the processing steps code, and flow rates codes.

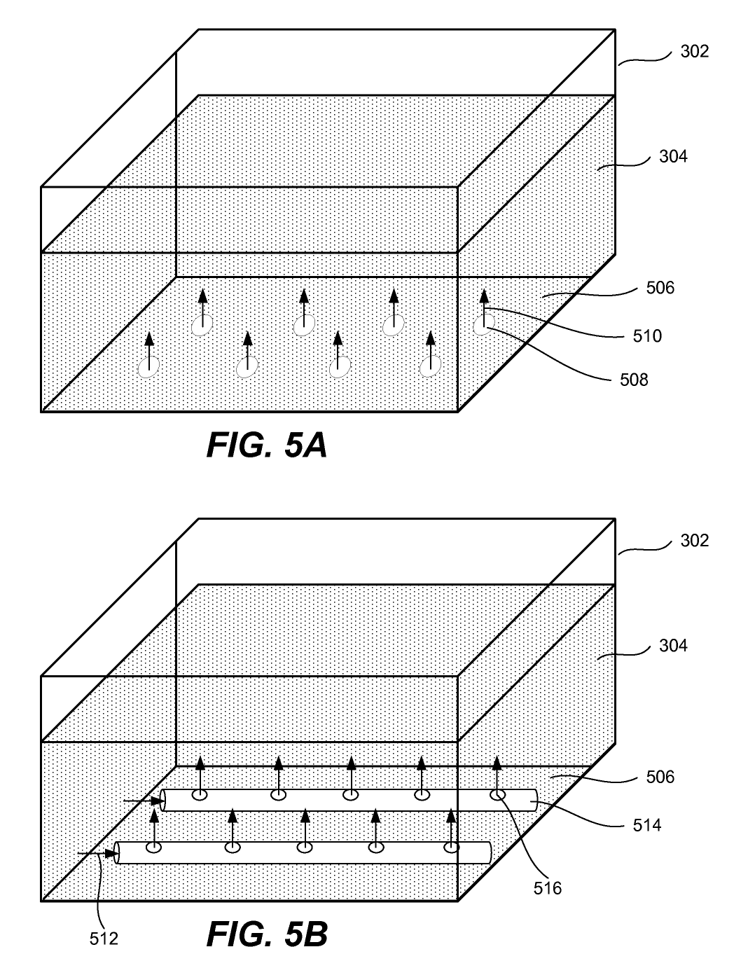

FIGS. 5A and 5B illustrate different views and examples of the processes for agitating bio-solids in wastewater using wastewater flow into the respective vessel 302. FIG. 5A shows the influent 304 and/or activated sludge entering the vessel 302 from an opening 508 near the bottom 506 of the vessel 302. In other example embodiments, pipes with orifices can be utilized. Size of the orifices should be small enough to provide velocity of the upwards of 15 feet per hour or higher. In other example embodiments, wastewater and/or bio-solids are discharged through multiple nozzles located close to the walls of the chamber. Horizontal and vertical angular directions of nozzles allow creating significant circular velocity that prevents settling of bio-solids.

In another example embodiment illustrated in FIG. 5B, a plurality of pipes 514 is placed on the bottom 506 of the vessel 302. The incoming influent 512 and/or activated sludge from either clarifier 530 or the activated sludge re-circulating within an aeration basin are flown through the pipes and escape through plurality of openings 516 in the pipes 514. For example, steel or plastic pipes having diameter of between about 0.2 inches and 2 inches may be used. Providing agitation with incoming influent and/or activated sludge may eliminate a need for addition agitation using other methods, such as gas (typically air) bubbling or mechanical mixing. In certain example embodiments, the bottom 506 may be uneven and have high and low points, wherein the openings for the incoming influent are provided at or around the low points as to avoid settling of bio-solids in between the openings.

Although the foregoing example embodiments of the present invention have been described in some detail for purposes of clarity of understanding, it will be apparent that certain changes and modifications may be practiced within the scope of the appended claims. It should be noted that there are many alternative ways of implementing the processes, systems and apparatus of the present invention. Accordingly, the present example embodiments are to be considered as illustrative and not restrictive, and the invention is not to be limited to the details of the embodiments provided herein.

What is claimed is:

1. A method of suspending of bio-solids in an activated sludge during wastewater treatment in an activated sludge system, the method comprising:
receiving an influent into the activated sludge system;
combining the influent with the bio-solids to form the activated sludge; and
maintaining the bio-solids suspended in the activated sludge by an intermittent agitation, the intermittent agitation comprising cycling between an agitation phase and a rest phase.

2. The method of claim 1, further comprising flowing of the activated sludge into a separation vessel through an open channel and wherein the intermittent agitation is utilized to suspend the bio-solids while the activated sludge flowing through the open channel.

3. The method of claim 1, wherein the activated sludge system comprises one or more anaerobic compartments.

4. The method of claim 3, further comprising treating the activated sludge under anaerobic conditions in the one or more anaerobic compartment and wherein the intermittent agitation is used in the one or more anaerobic compartment to suspend the bio-solids in the activated sludge during the treatment of the activated sludge in the one or more anaerobic compartment.

5. The method of claim 1, wherein the duration of the agitation interval is between about 30 seconds and 15 minutes and the duration of the rest interval is between about 30 seconds and one hour.

6. The method of claim 1, wherein the duration of the agitation interval is between about 30 seconds and 5 minutes and the duration of the rest interval is between about 3 minutes and 30 minutes.

7. The method of claim 1, further comprising regulating the duration of the rest interval based on one or more of the following: a settling velocity of the bio-solids, a location of an interface between water and the bio-solids, and a concentration of the bio-solids.

8. The method of claim 7, wherein the determining of the settling velocity is performed using a settleometer.

9. The method of claim 7, wherein the determining of the settling velocity is performed based on a sludge volume index and a solids concentration.

10. The method of claim 7, wherein the duration of the rest interval is regulated based on a location of the solids-water interface.

11. The method of claim 10, wherein the determining of the interface is performed using a sludge blanket detector.

12. The method of claim 1, wherein the duration of the rest interval is regulated based on changes of the concentration of bio-solids near the bottom over a period of time.

13. The method of claim 12, further comprising determining a second concentration in a second location that is not near the bottom of the activated sludge, wherein regulating the duration of the rest interval is based on comparison of the concentration of the bio-solids near the bottom of the activated sludge and the second concentration of the bio-solids.

14. The method of claim 1, wherein the intermittent agitation comprises a system supplying small amount of gas to the activated sludge system.

15. The method of claim 1, wherein the intermittent agitation comprises mechanical mixing.

16. The method of claim 15, wherein the mechanical mixing is performed using a propeller blade.

17. An activated sludge system for treating wastewater, the system comprising:
an anaerobic compartment to receive an activated sludge and to treat the activated sludge under the anaerobic conditions; and
an open channel for delivering the activated sludge into a separation vessel, wherein the bio-solids are maintained suspended in the in the anaerobic compartment by one or more of the following: an upright flow of the wastewater, an upright flow of the activated sludge, a rotating flow of the wastewater and/or a rotating flow of the activated sludge.

18. The system of claim 17, wherein the upstream flow of the wastewater is generated by discharging the wastewater through a plurality of opening located on the bottom of the anaerobic chamber.

19. The system of claim 17, wherein the rotating flow is generated by discharging the wastewater or activated sludge through a plurality of nozzles, the nozzles being substantially parallel with respect to each other.
